(19) United States
(12) Patent Application Publication
(10) Pub. No.: US 2025/0222608 A1
(43) Pub. Date: Jul. 10, 2025

(54) HAIR REMOVAL SYSTEM

(71) Applicant: The Gillette Company LLC, Boston, MA (US)

(72) Inventors: Robert Andrew Kearney, Reading (GB); Hannah Bryony Roberts, Ferndown (GB); Matthias Gester, Farnborough (GB)

(21) Appl. No.: 19/011,939

(22) Filed: Jan. 7, 2025

Related U.S. Application Data
(60) Provisional application No. 63/618,644, filed on Jan. 8, 2024.

(51) Int. Cl. B26B 21/44; B26B 21/40; B26B 21/56

(52) U.S. Cl. CPC B26B 21/443; B26B 21/56; B26B 21/4087

(57) ABSTRACT

A shaving assembly with a housing. A first cutting array is mounted to the housing. The first cutting array has a plurality of non-linear cutting edges. A second cutting array is mounted to the housing. The second cutting array has a plurality of non-linear cutting edges. A first lubricating member is positioned around the first cutting array. A second lubricating member is positioned around the second cutting array.

### FIELD OF THE INVENTION

The present disclosure relates generally to devices for hair removal and more specifically to devices for body and back hair removal.

### BACKGROUND OF THE INVENTION

The discussion of shortcomings and needs existing in the field prior to the present disclosure is in no way an admission that such shortcomings and needs were recognized by those skilled in the art prior to the present disclosure.

Hairs on the body grow in many directions, with hairs located next to each other or in close proximity to one another, often growing in very different directions. Today's wet shave razors require the hairs to be approached by the blade in a particular direction to ensure that they are cut effectively. Hairs which are cut by a blade travelling in a direction opposite to the direction of growth, often termed up-strokes, are cut closer and more consistently than hairs which are cut by a blade travelling perpendicular to the direction of hair growth. To compensate for this shortcoming, it is necessary for the user to take lots of strokes in multiple directions to ensure that all of the hairs are removed effectively. A further shortcoming of today's wet shave razors is that they must only be used to perform strokes which are perpendicular with the direction of the blade edge to ensure that there is no slicing motion of the blade relative to the skin, since this can result in nicks and cuts. When shaving areas of the body which are difficult to reach, such as the back, it can be particularly difficult to ensure that there is no lateral movement of the blade relative to the skin. This results in the user having to expend significant amounts of energy to try to maintain linear strokes or having to ask a third party to help them to remove the hair or for the user to compromise on the safety of their shave.

Many consumers find it desirable to shave within a wet shaving environment, such as within a bathtub or shower. Unfortunately, the water within the wet shaving environment typically removes the shaving gel or other pre-shave moisturizer or lubrication before the surface can be shaved. As a result, the benefits of the shaving gel or other pre-shave moisturizer or lubrication are minimized, resulting in a less comfortable shaving experience and greater irritation. In addition, areas of the body that are difficult to reach with a shaving device are also difficult to reach to apply shaving gel or other pre-shave moisturizer or lubrication.

Currently known shaving devices for areas of the body which are difficult to reach are also difficult for the user to see. Accordingly, a user may not be confident that they shaved all the necessary areas that they want to remove hair. This problem may be exacerbated by the various advancements in razor technology that have almost eliminated any blade feel by the user during shaving. Thus, a user may not only be unable to see where they are shaving, but they may not be able to feel where they may have already shaved.

Therefore, a need has been identified for a hair removal device to improve one or more of the problems above.

### SUMMARY OF THE INVENTION

Various examples disclosed herein solve the above-mentioned problems by providing devices capable of multi-directional hair removal, particularly when shaving back or body hair.

In one aspect, the invention features, in general a shaving assembly with a housing. A plurality of cutting arrays are mounted to the housing. Each of the cutting arrays has a plurality of non-linear cutting edges. A plurality of protrusions extends from the housing. The plurality of protrusions are positioned between adjacent cutting arrays. In another aspect, the invention features, in general a shaving assembly having a housing. A plurality of cutting arrays are mounted to the housing. Each of the cutting arrays has a plurality of non-linear cutting edges defining a shave plane. A plurality of protrusions extends from the housing. The plurality of protrusions are positioned along a perimeter of the housing. The plurality of protrusions are positioned on a plane above the shave plane.

In another aspect, the invention features, in general a shaving assembly having a housing defining a perimeter. A plurality of cutting arrays are positioned within the perimeter of the housing. Each of the cutting arrays has a plurality of non-linear cutting edges. A lubricating member positioned along the perimeter.

In another aspect, the invention features, in general a shaving assembly having a housing defining a perimeter. A plurality of cutting arrays is positioned within the perimeter of the housing. Each of the cutting arrays has a plurality of non-linear cutting edges positioned on a shave plane. A lubricating member is positioned between a first pair of adjacent cutting arrays.
In another aspect, the invention features, in general a shaving assembly having a housing. A first cutting array is mounted to the housing. The first cutting array has a plurality of non-linear cutting edges. A second cutting array is mounted to the housing. The second cutting array has a plurality of non-linear cutting edges. A first lubricating member is positioned around the first cutting array. A second lubricating member positioned around the second cutting array.

These and other features, aspects, and advantages of various embodiments will become better understood with reference to the following description, figures, and claims.

### BRIEF DESCRIPTION OF THE DRAWINGS

Many aspects of this disclosure can be better understood with reference to the following figures.

FIG. 1 is top perspective view of a hair removal system.

FIG. 2 is top view of a cutting array of the hair removal system of FIG. 1

FIG. 3 is top view of a plurality of protrusions of the hair removal system of FIG. 1

FIG. 4 is top view of a plurality of protrusions of the hair removal system of FIG. 1

FIG. 5 is top view of a lubrication member of the hair removal system of FIG. 1

FIG. 6 is an enlarged cross sectional view of the shaving assembly, taken generally along the line 6-6 of FIG. 1.

FIG. 7 is an enlarged cross sectional view of the shaving assembly, taken generally along the line 6-6 of FIG. 1.

FIG. 8 is a top view of another example of an embodiment of a shaving assembly.

FIG. 9 is a top view of another example of an embodiment of a shaving assembly.

FIG. 10 is a top view of another example of an embodiment of a shaving assembly.

It should be understood that the various embodiments are not limited to the examples illustrated in the figures.

### DETAILED DESCRIPTION OF THE INVENTION

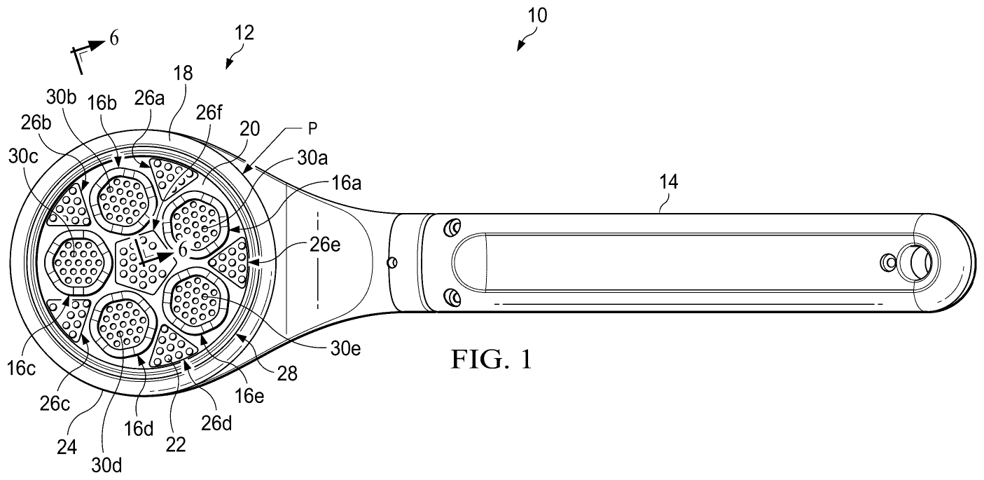

Referring to FIG. 1, a front perspective view of a hair removal system 10 is illustrated. The hair removal system 10 may include a shaving assembly 12 mounted to a handle 14. The shaving assembly 12 may include a plurality of cutting arrays 16 (e.g., 16a, 16b, 16c, 16d and 16e) mounted to a housing 18. The plurality of cutting arrays 16 (e.g., 16a, 16b, 16c, 16d and 16e) may be positioned within a perimeter “P” of the housing 18. Although five cutting arrays 16a, 16b, 16c, 16d and 16e are illustrated, it is understood that more or less cutting arrays 16a, 16b, 16c, 16d and 16e may be mounted to the housing 18 depending on the desired size of the shaving assembly 12 and the relative size of the area to be shaved. For example, the shaving assembly 12 may have a skin contacting surface area of about 3,000 mm² to about 6,000 mm². A smaller surface area may be preferred for smaller body regions, such as the chest and shoulders and a larger surface area may be preferred for the back. The housing 18 may have a planar top surface 20 that is rigid (i.e., does not flex or contort under normal shaving conditions). The housing 18 may be generally circular in shape. In certain embodiments, the housing 18 may comprise a material having a Shore D hardness of about 20 to about 120. A rigid housing 18 may provide for more efficient cutting of hair over a larger skin surface area having less contours, such as the back. As shown in FIG. 1, the plurality of cutting arrays 16a, 16b, 16c, 16d and 16e may have a generally circular shape, but other shapes are also possible, such as triangles, squares, pentagons, hexagons, octagons, semi-circles, and combinations thereof. The plurality of cutting arrays 16a, 16b, 16c, 16d and 16e may be arranged in a generally circular pattern along the top surface 20 of the base 18. However, it is understood that the cutting arrays 16a, 16b, 16c, 16d and 16e may arranged in numerous other types of patterns.

A plurality of protrusions 22 may extend upwardly from the housing 18. The plurality of protrusions 22 may be positioned between immediately adjacent cutting arrays 16a, 16b, 16c, 16d and 16e. As will be explained in greater detail below, the protrusions 22 may be spaced apart by about 0.25 mm to about 5 mm, and more preferably about 0.5 mm to about 2 mm. The protrusions 22 may have a height of about 0.25 mm to about 10 mm and more preferably about 0.5 mm to about 2 mm. The protrusions 22 may have an aspect ratio in the range 1:20 to 20:1 In certain embodiments, the plurality of protrusions may be positioned along an outer perimeter 24 of the top surface 20 of the housing 18. In certain embodiments, the protrusions 22 may comprise a material having a Shore D hardness of about 20 to about 120, which may provide for more improved tactile feedback as a consumer is using the shaving assembly on their back. Tactile feedback is important for shaving the back because the user is typically not able to see their back as they are shaving. Accordingly, users must rely on tactile feedback from the protrusions 22. Although blades, such as the cutting arrays 16a, 16b, 16c, 16d and 16e may provide tactile feedback, blade technologies are developed to reduce irritation and blade feel, thus minimizing any tactile feedback that may be provided. However, it is understood that softer materials (e.g., Shore A 20 to 60) may be more desirable for shaving other areas of the body.

In certain embodiments, the plurality of protrusions 22 may be arranged on one or more skin pads 26a, 26b, 26c, 26d and 26e. In certain embodiments, the skin pads 26a, 26b, 26c, 26d and 26e may comprise the same material as the housing 18. The skin pads 26a, 26b, 26c, 26d and 26e may be positioned between two or more adjacent cutting arrays 16a, 16b, 16c, 16d and 16e. For example, the skin pad 26a may be positioned between the cutting array 16a and the cutting array 16b; the skin pad 26b may be positioned between the cutting array 16b and the cutting array 16c; the skin pad 26c may be positioned between the cutting array 16c and the cutting array 16d;

the skin pad 26d may be positioned between the cutting array 16d and the cutting array 16e. It is understood that a portion of the skin pads 26a, 26b, 26c, 26d, 26e and 26f can be positioned between immediate adjacent cutting arrays 16a, 16b, 16c, 16d and 16e. In certain embodiments, the skin pads 26a, 26b, 26c, 26d may be positioned along the outer perimeter 24 of the top surface 20 of the housing 18. The skin pads 26a, 26b, 26c, 26d and 26e may have a triangular shape to better fit in-between the adjacent cutting arrays 16a, 16b, 16c, 16d and 16e. For example, a narrow end of the skin pads 26a, 26b, 26c, 26d and 26e may be positioned between adjacent cutting arrays 16a, 16b, 16c, 16d and 16e and a wider end of the triangle may be positioned along the outer perimeter 24 of the top surface 20 of the housing 18. In certain embodiments, one or more of the skin pads 26f may be positioned in a center of the housing 18, e.g., between all of the cutting arrays 16a, 16b, 16c, 16d and 16e.

One or more lubricating members 28 may be mounted to the housing 18 along the outer perimeter 24 of the top surface 20. In certain embodiments, the lubricating member 28 may form at least a partial ring. The ring can be formed by a lubricating member 28, but two or more can be touching at or about their terminal ends, or even overlapping, to form such a ring. The skin lubricating members 28 of the present invention typically allow for the loading of various lubricating materials onto a hair removal device for delivery during the hair removal process. The details of the skin lubricating members 28 and its location will be disclosed herein with figures showing exemplary embodiments which can include various elements of the present invention. Those of skill in the art will understand that various combinations of elements described in the specification and disclosed in the figures can be used in accordance with the present invention. The lubricating member 28 is intended to be suitable for use during the hair removal process, such as shaving, and the lubricating material(s) can therefore include various known compounds commonly used for topical application in personal care.

The lubricating members 28 may comprise a lubricant, or lubricating material. The lubricating material can be in various forms, as well as mixtures/combinations thereof, as will be described below. The lubricating material may include a copolymer of polyethylene oxide (PEO) and polypropylene oxide (PPO) to improve the lubrication properties of the lubricating member 28. The PEO/PPO copolymer may have any average molecular weight. Advantageously, the PEO/PPO copolymer has an average molecular weight of at least 5,000, preferably in the range of from 10,000 to 20,000, more preferably from 11,000 to 15,000, even more preferably from 12,000 to 13,000 and even more preferably still from 12,250 to 12,750. Without wishing to be bound by theory, the inclusion of a PEO/PPO copolymer of sufficient molecular weight is thought to further improve the lubrication properties of the lubricating member 28 in aqueous conditions, especially in combination with a further water soluble polymer (particularly polyethylene oxide), and thus prevent an undesirable feeling in use.

The PEO/PPO copolymer may be of any arrangement but is advantageously a block copolymer, for example a di-block, tri-block, multi-block, radial-block or random-block copolymer. Preferably, the PEO/PPO copolymer is a tri-block copolymer, more preferably a tri-block copolymer having the sequence: PEO-PPO-PEO. Such tri-block copolymers of PEO and PPO are commercially available under tradenames such as Pluracare from BASF and Pluronic from Sigma-Aldrich.

The PEO/PPO copolymer may have any weight ratio of PEO to PPO (i.e. of ethylene oxide repeat units to propylene oxide repeat units), for example anywhere from 1000:1 to 1:1000 or from 100:1 to 1:100. Advantageously, the weight ratio is selected to improve the solubility properties of the PEO/PPO copolymer in a system comprising a water-soluble polymer (especially polyethylene oxide) and water, and so may be from 10:1 to 1:10, preferably from 1:1 to 1:7 (or any ratio in which the weight of PPO is greater than or equal to the weight of PEO), more preferably from 1:2 to 1:5, even more preferably from 1:2.5 to 1:4 and even more preferably still from 1:2.5 to 1:3.

An alternative way of describing the solubility properties of the PEO/PPO copolymer is through the well-known hydrophilic-lipophilic balance (HLB). The PEO/PPO copolymer may have an HLB of from 0 to 50, but advantageously will have an HLB in the range of from 1 to 30, preferably from 5-25, more preferably from 10-25, even more preferably from 17-24 and even more preferably still from 18-23.

The PEO/PPO copolymer is typically present at an amount of from 0.01% to 50% by weight of the lubricating material, or by weight of the lubricating member 28. Preferably, the PEO/PPO copolymer is present at an amount of from 0.01% to 50%, preferably from 2% to 40%, more preferably from 3% to 25%, even more preferably from 4% to 20% and even more preferably still from 5% to 10% by weight of the lubricating material or by weight of the lubricating member 28, in order to provide an improved balance between any further water soluble polymer providing lubrication and the PEO/PPO copolymer to address the problems associated with the water soluble polymer. The remainder of the lubricating material may be entirely other water soluble polymer(s) (e.g. partially or entirely polyethylene oxide), or a mixture of further ingredients.

The lubricating material may also comprise a further water soluble polymer, typically intended to provide lubrication in-use. Examples of water soluble polymers include polyethylene oxide, polyvinyl pyrrolidone, polyacrylamide, polyhydroxymethacrylate, polyvinyl imidazoline, polyethylene glycol, polyvinyl alcohol, polyhydroxyethymethacrylate, silicone polymers, and a mixtures thereof. In some embodiments, said water soluble polymer is selected from the group consisting of polyethylene oxide, polyethylene glycol, and mixtures thereof.

The water-soluble polymer will preferably comprise at least about 50%, more preferably at least about 60%, by weight of the lubricating member 28, up to about 99%, (or up to about 90% of the lubricating material). For example, the water-soluble polymer may be present at an amount of at least about 50%, preferably from about 50% to about 99.9%, more preferably from about 60% to about 95% (e.g. from about 90% to about 95%) and even more preferably from about 70% to about 90% by weight of the lubricating material. Not all of the water-soluble polymer needs to meet the average molecular weight requirement, for example a blend of two or more grades of polyethylene oxide could be used wherein at least one, but less than all, of the grades meets the average molecular weight attribute, but the total amount of polyethylene oxide is within one of the ranges above. Alternatively, the average molecular weight for the entirety of the water-soluble polymer (especially polyethylene oxide) may fall within the desired average molecular weight range as well as the total amount of water-soluble polymer (especially polyethylene oxide) being according to one or more of the ranges above.

The more preferred water soluble polymers are the polyethylene oxides generally known as POLYOX (available from Union Carbide Corporation) or ALKOX (available from Meisei Chemical Works, Kyoto, Japan). The water soluble polymer, (especially these polyethylene oxides), will preferably have average molecular weights of at least about 5,000, at least about 20,000, at least about 50,000, at least about 100,000 or from about 100,000 to 6 million, preferably about 300,000 to 5 million. A particularly preferred polyethylene oxide comprises a blend of about 40% to 80% of polyethylene oxide having an average mol·wt. of about 5 million (e.g. POLYOX COAGULANT) and about 60% to 20% of polyethylene oxide having an average mol·wt. of about 300,000 (e.g. POLYOX WSR-N-750). The polyethylene oxide blend may also advantageously contain up to about 10% (for example about 5%) by weight of a low mol·wt. (i.e. MW<10,000) polyethylene glycol such as PEG-100.

The lubricating material can further comprise a water-insoluble polymer, e.g. in which the other components of the lubricating material are dispersed, which may be referred to as a water-insoluble matrix and may be helpful to improve the flow of the lubricating material when molten, e.g. if molding the lubricating material into the carrier. Desirably, the water insoluble polymer may be present at a level of from about 0.01% to about 50%, preferably from about 0.1% to about 30%, more preferably from about 0.5% to about 20% and even more preferably from about 1% to about 10% by weight of the lubricating material.

Suitable water-insoluble polymers which can be used include polyethylene (PE), polypropylene, polystyrene (PS), butadiene-styrene copolymer (e.g. medium and high impact polystyrene), polyacetal, acrylonitrile-butadiene-styrene copolymer, ethylene vinyl acetate copolymer, polyurethane, and blends thereof such as polypropylene/polystyrene blend or polystyrene/impact polystyrene blend.

One preferred water-insoluble polymer is polystyrene, preferably a general purpose polystyrene, such as NOVA C2345A, or a high impact polystyrene (HIPS) (i.e. polystyrene-butadiene), such as BASF 495F KG21. The lubricating material or any portion thereof may contain a sufficient quantity of water-insoluble polymer to provide additional mechanical strength, both during production and use.

In some embodiments, the lubricating material comprises any other ingredients commonly found in commercially available shaving aid members or lubricating member 28, such as those used on razor cartridges by Gillette, Schick or BIC. Non-limiting examples of such lubricating member 28 include those disclosed in U.S. Pat. Nos. 6,301,785, 6,442,839, 6,298,558, 6,302,785, and U.S Patent Pubs 2008/060201, and 2009/0223057.

The lubricating member 28 r or lubricating material may therefore contain other conventional shaving aid ingredients, such as low mol·wt. water-soluble release enhancing agents such as polyethylene glycol (MW<10,000, e.g., 1-10% by weight PEG-100), water-swellable release enhancing agents such as cross-linked polyacrylics (e.g., 2-7% by weight), colorants, skin care actives, surfactants, soaps (including interrupted soaps), antioxidants, preservatives, emollients, lipids, oils, waxes, fats, cooling agents (especially non-volatile cooling agents), essential oils, beard softeners, astringents, medicinal agents, plasticizers, additional lubricants, depilatories/keratolytic materials, tackifiers, skin-soothing agents, fragrances, compatibilizers, anti-inflammatory agents, antipruritic/counterirritant materials etc.

Portions that contain a colorant can be designed to release the colorant (e.g., by leaching or abrasion), and thereby cause the lubricating member 28 (or a portion thereof) to change color during shaving, preferably in response to wear of the colored portion, so as to provide an indication to the user that the lubricating member 28 and/or the hair removal cartridge (e.g. razor cartridge) has reached the end of its effective life or the end of its optimum performance. A portion may contain, for example, between about 0.1% and about 5.0% (preferably between about 0.5% and 3%) colorant by weight.

In some embodiments, the lubricating material further comprises from about 0.5% to about 50%, preferably from about 1% to about 20%, polycaprolactone (preferably mol· wt. of 30,000 to 60,000). See U.S. Pat. No. 6,302,785.

In some embodiments, the lubricating member 28 further comprises another shaving aid ingredient, for example selected from the group consisting of polyvinyl pyrrolidone, polyacrylamide, hydroxypropyl cellulose, polyvinyl imidazoline, polyethylene glycol, poly vinyl alcohol, polyhydroxyethylmethacrylate, silicone copolymers, sucrose stearate, vitamin E, panthenol, aloe, polyethylene glycol, silicone oil, Teflon® polytetrafluoroethylene powders (manufactured by DuPont), menthol, camphor, eugenol, eucalyptol, safrol and methyl salicylate; tackifiers such as Hercules Regalrez 1094 and 1126, cyclodextrins, inclusion complexes of skin-soothing agents with cyclodextrins; antimicrobial/keratolytic materials such as Resorcinol; anti-inflammatory agents such as Candilla wax and glycyrrhetinic acid; astringents such as zinc sulfate;

surfactants such as iconol materials; compatibilizers such as styrene-b-EO copolymers; mineral oil, polycaprolactone (PCL), and combinations thereof.

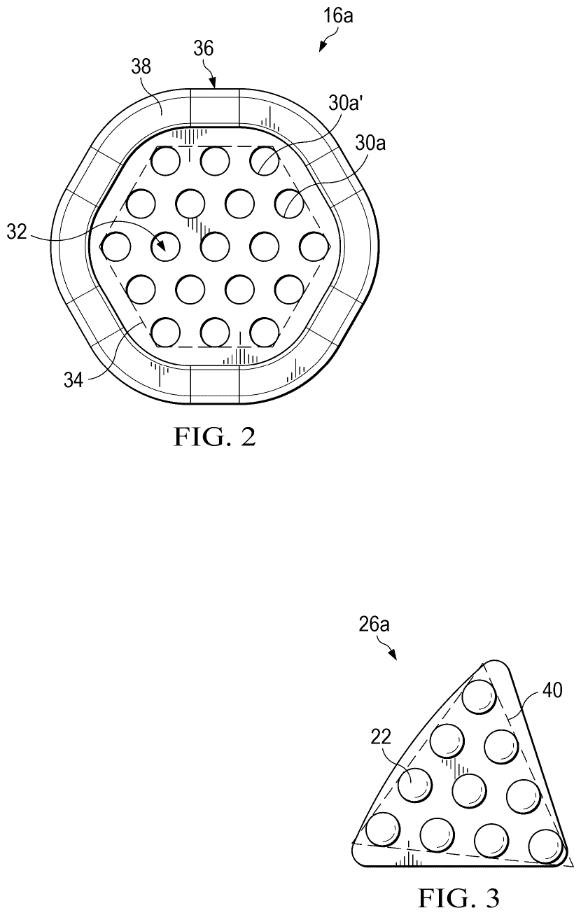

The cutting arrays 16a, 16b, 16c, 16d and 16e may each include a plurality of corresponding non-linear (e.g., circular) cutting edges 30a, 30b, 30c, 30d and 30e. The non-linear cutting edges 30a, 30b, 30c, 30d and 30e may provide for multi-directional cutting of hair. Adjacent non-linear cutting edges 30a, 30b, 30c, 30d and 30e within one of the cutting arrays 16a, 16b, 16c, 16d and 16e are spaced closer together than non-linear cutting edges from different cutting arrays 16a, 16b, 16c, 16d and 16e to provide a cluster or grouping (i.e., no other skin contacting elements within the array other than the respective cutting edges 30a, 30b, 30c, 30d and 30e). For example, a pair of adjacent non-linear cutting edges 30a and 30a′ within one of the cutting arrays 16a (FIG. 2) may be spaced closer together than one of the cutting edges 30a within the cutting array 16a closest to one of the cutting edges 30b from the adjacent cutting array 16b (FIG. 1). In certain embodiments, all of the cutting edges 30a within one of the respective cutting arrays 16a may be spaced closer to each other than any of the cutting edges 30a from that cutting array 16a are spaced to the nearest cutting edges 30b of the closest adjacent cutting array 16b.

Referring to FIG. 2, an enlarged view of one of the cutting arrays 16a is illustrated as a representative example of the cutting arrays 16b, 16c, 16d and 16e. The cutting arrays 16a, 16b, 16c, 16d and 16e are defined by a grouping of closely spaced apart non-linear cutting edges 30. In certain embodiments, the non-linear cutting edges may be enclosed such that the non-linear cutting edges 30a, 30b, 30c, 30d and 30e face inwardly and define an opening 32 for hair to enter and to be cut (e.g., the cutting edges face inwardly). The cutting array 16a is defined as a grouping of the plurality of cutting edges 30a within a perimeter 34 such that no other skin contacting elements are positioned within the perimeter 34 (e.g., between adjacent cutting edges 30a). In certain embodiments, the perimeter 34 may have a polygonal shape, such as a hexagon, but other shapes are also possible, such as circles, semicircles and combinations thereof. Although nineteen of the cutting edges 30a are illustrated in FIG. 2, it is understood more, or less cutting edges may be provided. For example, the cutting array 16a may include 2 to 10 cutting edges 30, 20 to 50 cutting edges, or even 75 to 200 cutting edges 30 arranged within the perimeter 34.

In certain embodiments, a clip 36 having a rim 38 may be positioned around the cutting edges 30a of the cutting array 16a. The clip 36 may facilitate the securing of the cutting arrays 16a, 16b, 16c, 16d and 16e to the housing 18 (FIG. 1). However, it is understood that other manufacturing methods may also be used, such as, staking, ultrasonic welding, insert injection molding, cold forming, press fits, snap fits, adhesives and combinations thereof. In certain embodiments, the rim 38 may have a polygonal shape, such as a parallelogram, a hexagon, pentagon, or octagon, but other shapes are also possible, such as circles, semicircles and combinations thereof. The perimeter 34 may define an area of about 7 mm² to about 800 mm², preferably about 50 mm² to about 500 mm² and more preferably about 75 mm² to about 200 mm². The total surface area available for shaving may be calculated by adding of the area (as defined by the perimeter 34) of each of the individual cutting arrays 16a, 16b, 16c, 16d and 16e on the housing 18 (FIG. 1). For example, the shaving assembly 12 of FIG. 1 may have a total area of about 35 mm² to about 4000 mm², preferably about 250 mm² to about 2500 mm² and more preferably about 375 mm² to about 1000 mm². It is understood the total area may be increased or decreased depending on the size of the area to be shaved. The neck and shoulders may benefit from a smaller total area compared to a total area for shaving the back. The total area may be increased or decreased by either changing the total number of cutting arrays provided or by changing the area defined by the individual perimeters 34 for each of the cutting arrays 16a, 16b, 16c, 16d and 16e on the housing 18 (FIG. 1). For example, the total area may be decreased by providing only two of the five cutting arrays cutting arrays 16a, 16b, 16c, 16d and 16e, resulting in a total area of about 14 mm² to about 1600 mm², preferably about 100 mm² to about 1000 mm² and more preferably about 150 mm² to about 400 mm². Similarly, the total area may be increased by providing ten of the cutting arrays cutting arrays 16a, 16b, 16c, 16d and 16e, resulting in a total area of 70 mm² to about 8000 mm², preferably about 500 mm² to about 5000 mm² and more preferably about 750 mm² to about 2000 mm².

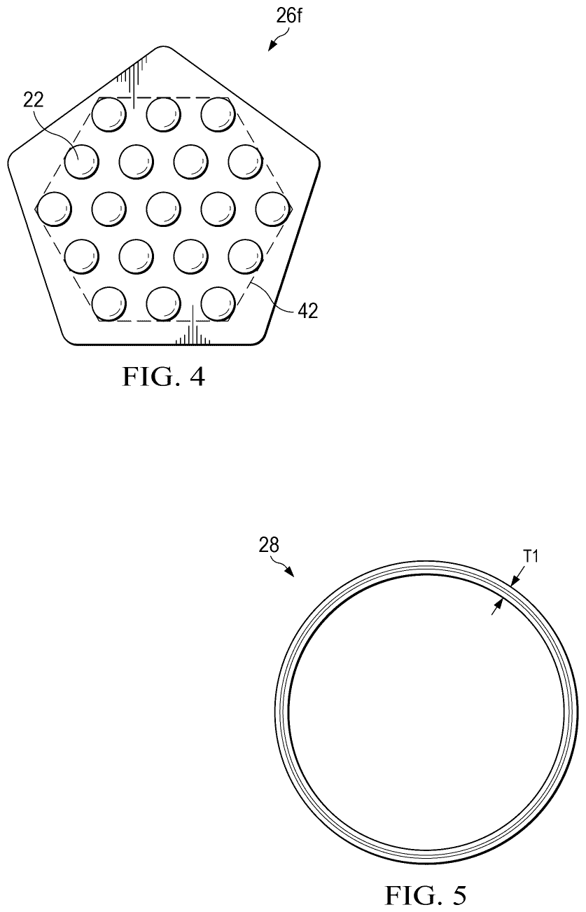

Referring to FIGS. 3 and 4, enlarged views of the plurality of protrusions 22 are illustrated. Similar to the cutting arrays 16a of FIG. 2, the plurality of protrusions 22 may be arranged within a perimeter 40, for example, on one or more of the skin pads (e.g., the skin pad 26a shown in FIG. 3). FIG. 4 illustrates another example of the plurality of protrusions 22 arranged within a perimeter 42, for example on the skin pad 26f. As shown in FIG. 1, the plurality of protrusions 22 may be grouped together on multiple spaced apart skin pads 26a, 26b, 26c, 26d and 26e. It is understood that the skin pads 26a, 26b, 26c, 26d and 26e are optional and the protrusions 22 may extend directly from the housing 18 (e.g., top surface 20). The skin pads 26a, 26b, 26c, 26d and 26e may facilitate the use of different materials for the protrusions 22 compared to the housing 18. FIGS. 3 and 4 illustrate that the perimeters 40 and 42 may have different shapes. Although a triangle and a hexagon are shown, numerous other shapes are also possible depending on the size, location, and arrangement of the cutting arrays 16a, 16b, 16c, 16d and 16e on the housing 18 (FIG. 1). The protrusions 22 may be spaced between the cutting arrays 16a, 16b, 16c, 16d and 16e and or along the outer perimeter 24 of the housing 18 (FIG. 1).

The plurality (e.g., two or more) of protrusions 22 may be positioned within the perimeter(s) 40 and 42 such that no other skin contacting elements are positioned within the perimeter(s) 40 and 42. For example, there may be no cutting elements positioned between adjacent protrusions 22 within a perimeter 40 and 42. In certain embodiments, the perimeter 40 may have a triangle shape. The triangle shape may facilitate positioning more protrusions between the cutting arrays 16a, 16b, 16c, 16d and 16e, especially if the housing 18 is generally circular shape, as shown in FIG. 1. Although 10 protrusions 22 are illustrated in FIG. 3 within the perimeter 40, it is understood more or less protrusions 22 may be provided. For example, within the perimeter 40 (e.g., on the skin pad 26a) there may be 3 to 10 protrusions 22; 10 to 20 protrusions 22; or even 20 to 50 protrusions 22.

In certain embodiments, the perimeter 42 may have a hexagon or generally circular shape. The hexagon or circular shape may facilitate positioning more protrusions 22 in the middle of a plurality of the cutting arrays 16a, 16b, 16c, 16d and 16e, especially if the housing 18 is generally circular shape, as shown in FIG. 1. Although 19 protrusions 22 are illustrated in FIG. 3 within the perimeter 42, it is understood more or less protrusions 22 may be provided. For example, within the perimeter 42 (e.g., on the skin pad 26f) there may be 3 to 10 protrusions 22; 10 to 20 protrusions 22; or even 20 to 50; protrusions 22. As shown in FIG. 1, the plurality of protrusions 22 may be grouped together on multiple spaced apart skin pads 26a, 26b, 26c, 26d and 26e.

In certain embodiments, the perimeter 40 may define an area of about 60 mm² to about 150 mm² and more preferably about 75 mm² to about 100 mm². In certain embodiments, the perimeter 42 may define an area of about 100 mm² to about 350 mm² and more preferably about 200 mm² to about 250 mm². The total surface area may be calculated by adding of the area for each of the perimeters (e.g. five triangle shaped perimeters 40 and one hexagon shaped perimeter 42) defined by the plurality of protrusions 22 on the housing. For example, the shaving assembly 12 of FIG. 1 may have a total area of about 800 mm² to about 6000 mm². It is understood the total area may be increased or decreased depending on the size of the area to be shaved. For example, shaving the shoulders may benefit from a smaller total area than shaving the back.

Referring to FIG. 5, a top view of the lubricating member 28 of FIG. 1 is shown. In certain embodiments, the lubricating member 28 may be a fully enclosed ring to provide lubrication in all directions. The lubrication member 28 may have a thickness “t1” of about 1 mm to about 10 mm and more preferably about 2 mm to about 5 mm. A surface area of the lubrication member 28 may be about 100 mm² to about 1000 mm². The lubrication member 28 may provide sufficient lubrication during shaving for all of the cutting arrays 16a, 16b, 16c, 16d and 16e positioned within the lubricating member 28 (FIG. 1). As will be described in greater detail below, the size and shape of the lubricating member 28 may be modified to provide additional lubrication for each of the cutting arrays 16a, 16b, 16c, 16d and 16e (FIG. 1). The above-described arrangement allows the protrusions 22 and cutting arrays 16a, 16b, 16c, 16d and 16e to both be contained with the lubricating member 28, so that the skin may be managed more consistently. In addition, more skin contact points may be provided by the separate cutting arrays 16a, 16b, 16c, 16d and 16e each having the respective clip 36 with the rim 38, thus providing more consistent skin contact and lubrication delivery.

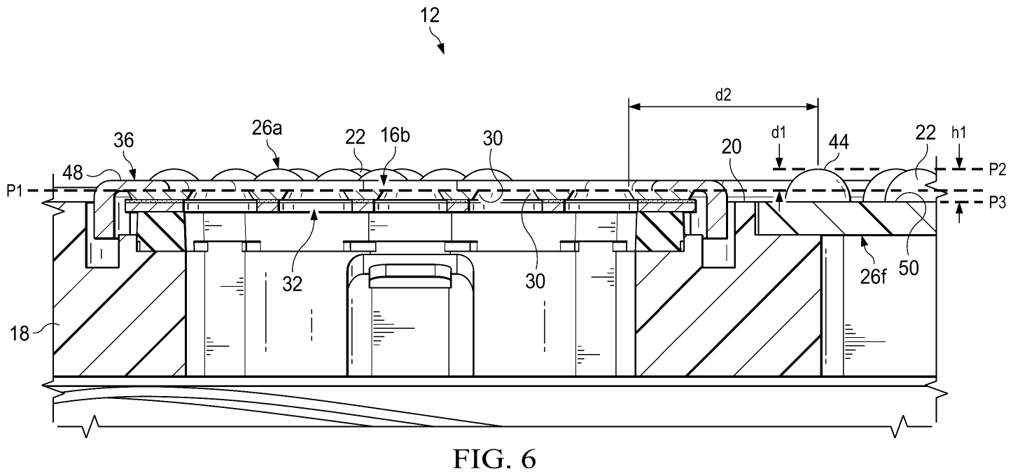

Referring to FIG. 6, an enlarged cross-sectional view of the shaving assembly 12, taken generally along the line 6-6 of FIG. 1 is shown, focusing on one of the cutting arrays 16b and skin pad 26f. However, it is understood that the other cutting arrays 16a, 16c, 16d, and 16e, as well as the other skin pads 26a, 26b, 26c, 26d and 26e may be substantially similar. In certain embodiments, the plurality of non-linear cutting edges 30a, 30b, 30c, 30d and 30e within one or more of the cutting arrays 16a, 16b, 16c, 16d and 16e may define a shave plane P1. Accordingly, the plurality of cutting arrays 16a, 16b, 16c, 16d and 16e (and the respective cutting edges 30a, 30b, 30c, 30d and 30e) shown in FIG. 1 may be coplanar (the cutting array 16b and non-linear cutting edge 30b are shown in FIG. 6 as an example). Hair may extend through the openings 32 and be cut by the non-linear cutting edges 30a, 30c, 30d and 30e. Although the cutting array 16b is illustrated in FIG. 6, it is understood that the other cutting arrays 16a, 16c, 16d and 16e and the corresponding plurality of non-linear cutting edges 30a, 30c, 30d and 30e may also be positioned on the same shave plane P1. The plurality of protrusions 22 (i.e., a top surface 44 of the protrusions 22) may extend from the housing 18 to a plane P2 that is positioned a distance dl above the shave plane P1. In certain embodiments, the distance d1 may be about −3 mm to about 3 mm (a negative value for the distance d1 would result in the protrusion 22 being below the plane P2). As shown in FIG. 6, the top surface 44 of the protrusions 22 may be tangent to the plane P2. It is understood that the dimensions of individual protrusions 22 may vary. The top surface 20 of the housing 18 may extend along a plane P3. Accordingly, the plane P3 may be positioned below the shave plane P1 less than zero mm to about 10 mm. The protrusions 22 may have a height h1 from plane P3 to plane P2 (e.g., to top surface 44 of the protrusion 22) of about 0.25 mm to about 10 mm and more preferably about 0.5 mm to about 2 mm. The clip 36 may have a top surface 48 positioned above the shave plane P1 and below the shave plane P2. The top surface 48 may be positioned below the plane P3. The position of the top surface 48 may help with the management and flow of skin across the shaving arrays 16a, 16b, 16c, 16d and 16e.

The protrusions 22 may extend from a skin pad, such as the skin pad 26f (or any of the skin pads 26a, 26b, 26c, 26d and 26e of FIG. 1). For example, the skin pad 26f may have a lower surface 50 that is positioned on the same plane P3 as the top surface 20 of the housing 18. The protrusions may extend far enough above the shave plane P1 to provide sufficient feedback to the user without negatively influencing shaving efficiency. In certain embodiments, the non-linear cutting edge 30 may be spaced apart from the closest protrusion 22, measured from the top surface 44 of the protrusion 22, by a distance d2 of about 2 mm to about 20 mm and more preferably about 4 mm to about 8 mm. The distance d2 may allow the skin (and hair) to flow over and sufficiently contact the non-linear cutting edges 30 of the cutting array(s) 16b to efficiently cut hair.

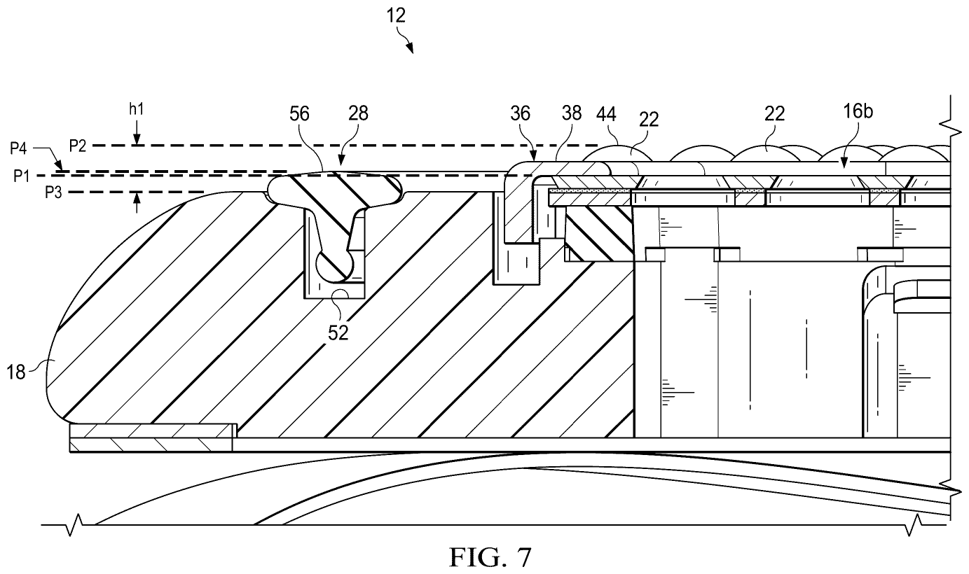

Referring to FIG. 7 an enlarged cross-sectional view of the shaving assembly 12, taken generally along the line 6-6 of FIG. 1 is shown, focusing on one of the cutting arrays 16b and the lubrication member 28. The lubrication member 28 may have a top surface 56 positioned on a plane P4 that is between the plane P2 and the shaving plane P1. The top surface 56 of the lubrication member 28 may be positioned below the top surface 44 of the protrusions 22 (e.g., the plane P2) so the lubrication member 28 does not mask the tactile feedback provided by the protrusions. In certain embodiments, the housing 18 may define one or more grooves 52 dimensioned to receive the lubrication member 28. The top surface 56 of the lubrication member 28 may be positioned below the rim 38 of the clip 36. It is understood that the lubrication member 28 may wear during shaving and the above arrangements are pre-shaving conditions.

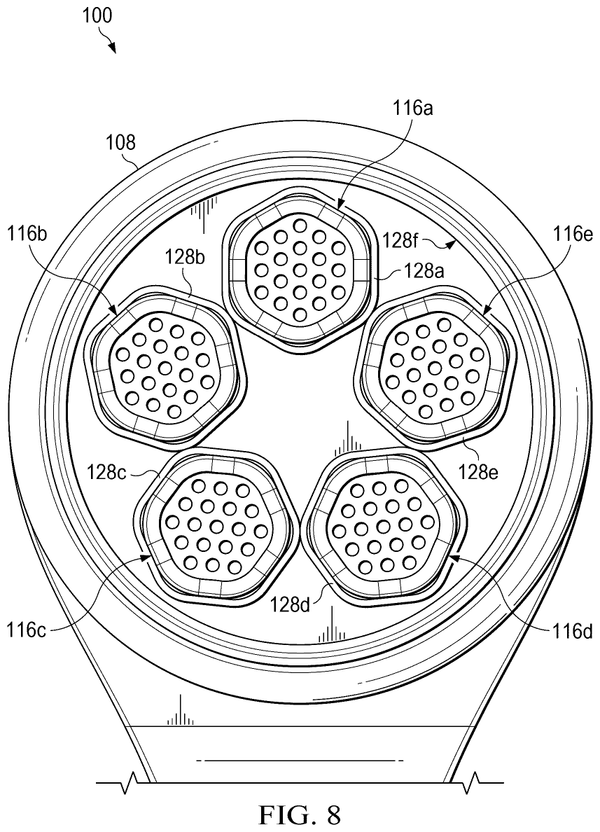

Referring to FIG. 8, a top view of an alternative embodiment of a shaving system 100 is illustrated. The shaving system 100 may be substantially the same as the shaving system 12 previously described. Although not shown, it is understood, the shaving system 100 may include a plurality of protrusions 22 positioned between a plurality of cutting arrays 116a, 116b, 116c, 116d and 116e. The plurality of cutting arrays 116a, 116b, 116c, 116d and 116e may be the same as the plurality of cutting arrays 16a, 16b, 16c, 16d and 16e described in FIG. 1. A lubrication member 128a, 128b, 128c, 128d and 128e may be positioned between adjacent cutting arrays 116a, 116b, 116c, 116d and 116e. For example, one of the lubrication members 128a, 128b, 128c, 128d and 128e may surround the respective cutting arrays 116a, 116b, 116c, 116d and 116e. Accordingly, lubrication may be delivered to each of the individual cutting arrays 116a, 116b, 116c, 116d and 116e. More lubrication may be beneficial to shaving hard to reach areas, such as the back, because users may have difficulty applying pre-shaving lotions. Accordingly, users may abandon the use of pre-shaving lotions, which may negatively impact the shaving experience. In certain embodiments, an external lubrication member 128f may be mounted to a housing 108 of the shaving system 100. The lubricating member 128a, 128b, 128c, 128d and 128e may be mounted to the housing 108 or to the cutting arrays 116a, 116b, 116c, 116d and 116e.

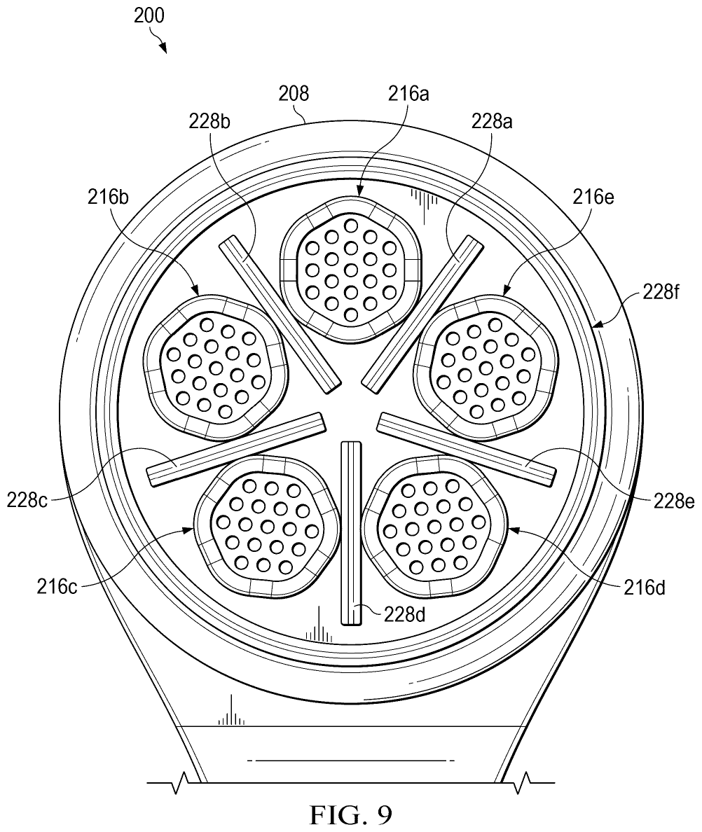

Referring to FIG. 9, a top view of alternative embodiment of a shaving system 200 is illustrated. The shaving system 200 may be substantially the same as the shaving system 12 previously described. Although not shown, it is understood, the shaving system 200 may include a plurality of protrusions 22 (not shown) positioned between a plurality of cutting arrays 216a, 216b, 216c, 216d and 216e, as previously discussed. The plurality of cutting arrays 216a, 216b, 216c, 216d and 216e may be the same as the plurality of cutting arrays 16a, 16b, 16c, 16d and 16e described in FIG. 1. A lubrication member 228a, 228b, 228c, 228d and 228e may be positioned between adjacent cutting arrays 216a, 216b, 216c, 216d and 216e. Similar to the shaving system 100 of FIG. 8, lubrication may be delivered to each of the individual cutting arrays 216a, 216b, 216c, 216d and 216e. In certain embodiments, an external lubrication member 228f may be mounted to a housing 208 of the shaving system 200. The lubrication members 228a, 228b, 228c, 228d and 228e may be in the form of extruded strips that are snapped, or press fit into the housing 208. Accordingly, the shaving system 200 provides a simpler execution to provide lubrication to each of the cutting arrays 216a, 216b, 216c, 216d and 216e by mounting relatively straight lubrication strips to the housing 208, which are easier to manufacture and assemble compared to circular shapes. In certain embodiments, adjacent lubricating members 228a, 228b, 228c, 228d and 228e may intersect at an angle of about 30 degrees to about 120 degrees. The lubricating members 228a, 228b, 228c, 228d and 228e need not touch to intersect, but only extend along a line that intersects a line that another one of the lubricating members 228a, 228b, 228c, 228d and 228e extends.

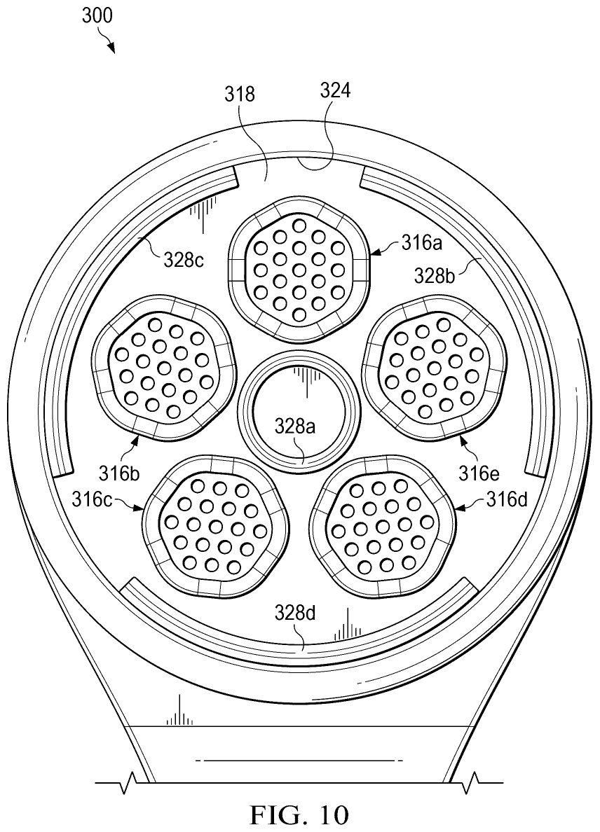

Referring to FIG. 10, a top view of an alternative embodiment of a shaving system 300 is illustrated. The shaving system 300 may be substantially the same as the shaving system 12 previously described. Although not shown, it is understood, the shaving system 300 may include a plurality of protrusions 22 positioned between a plurality of cutting arrays 316a, 316b, 316c, 316d and 316e. The plurality of cutting arrays 316a, 316b, 316c, 316d and 316e may be the same as the plurality of cutting arrays 16a, 16b, 16c, 16d and 16e described in FIG. 1. A lubrication member 328a may be positioned on a housing 318 in the middle of the plurality of cutting arrays 316a, 316b, 316c, 316d and 316e. Accordingly, the lubrication member 328a may be able to deliver lubrication to each of the cutting arrays 316a, 316b, 316c, 316d and 316e as the shaving system 300 is moved back and forth across a user's body. In certain embodiments, one or more lubrication members 328b, 328c and 328d may be positioned around a periphery of the plurality of cutting arrays 316a, 316b, 316c, 316d and 316e, for example, along a perimeter 324 of the housing 318. The lubrication members 328b, 328c and 328d may be similar to the lubrication member 28 of FIG. 1 and provide similar benefits. However, the lubrication members 328b, 328c and 328d may be spaced apart from each other, thus providing a discontinuous ring, which may allow for easier manufacturing and assembly of the lubrication members 328b, 328c and 328d.

The dimensions and values disclosed herein are not to be understood as being strictly limited to the exact numerical values recited. Furthermore, dimensions should not be held to an impossibly high standard of metaphysical identity that does not allow for discrepancies due to typical manufacturing tolerances. Therefore, the term “about” should be interpreted as being within typical manufacturing and measurement tolerances.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A shaving assembly comprising:
a housing having a perimeter;
a plurality of cutting arrays positioned within the perimeter of the housing, each of the cutting arrays having a plurality of non-linear cutting edges;
a lubricating member positioned along the perimeter.

2. The shaving assembly of claim 1 wherein the lubricating member is an enclosed ring.

3. The shaving assembly of claim 1 wherein the lubricating member is segmented.

4. The shaving assembly of claim 1 wherein the perimeter of the housing defines a groove, and the lubricating member is mounted within the groove.

5. The shaving assembly of claim 1 wherein each of the cutting arrays comprising a rim extending around the non-linear cutting edges.

6. The shaving assembly of claim 1 wherein the lubrication member is positioned on a plane above a shaving plane defined by the non-linear cutting edges.

7. The shaving assembly of claim 1 wherein each of the cutting arrays is coplanar.

8. The shaving assembly of claim 1 wherein the cutting arrays are rigid.

9. The shaving assembly of claim 1 further comprising a plurality of protrusions extending from the housing to a plane that is positioned above a shave plane defined by the non-linear cutting edges.

10. A shaving assembly comprising:
a housing having a perimeter;
a plurality of cutting arrays positioned within the perimeter of the housing, each of the cutting arrays having a plurality of non-linear cutting edges positioned on a shave plane; and
a lubricating member positioned between a first pair of adjacent cutting arrays.

11. The shaving assembly of claim 10 wherein the housing defines a groove, and the lubricating member is mounted within the groove.

12. The shaving assembly of claim 10 further comprising a lubricating member positioned between a second pair of adjacent cutting arrays.

13. The shaving assembly of claim 12 wherein the lubricating members intersect at an angle of about 30 degrees to about 120 degrees.

14. The shaving assembly of claim 10 wherein each of the cutting arrays comprises a rim extending around the respective non-linear cutting edges.

15. The shaving assembly of claim 14 wherein the lubrication member is positioned on a plane below the rim.

16. The shaving assembly of claim 10 wherein the plurality of cutting arrays are coplanar.

17. The shaving assembly of claim 10 wherein the plurality of cutting arrays are rigid.

18. A shaving assembly comprising:
a housing;
a first cutting array mounted to the housing, the first cutting array having a plurality of non-linear cutting edges;
a second cutting array mounted to the housing, the second cutting array having a plurality of non-linear cutting edges;
a first lubricating member positioned around the first cutting array; and
a second lubricating member positioned around the second cutting array.

19. The shaving assembly of claim 18 wherein the first lubricating member is positioned on a plane below a shave plane of the non-linear cutting edges of the first cutting array or second cutting array.

20. The shaving assembly of claim 18 further comprising a lubricating member extending along a perimeter of the housing.
